(19) United States
(12) Patent Application Publication
(10) Pub. No.: US 2014/0075186 A1
(43) Pub. Date: Mar. 13, 2014

(54) Multiple Access Key Fob

(71) Applicant: Juergen Austen, Fraunberg (DE)

(72) Inventor: Juergen Austen, Fraunberg (DE)

(73) Assignee: TEXAS INSTRUMENTS INCORPORATED, Dallas, TX (US)

(21) Appl. No.: 13/613,688

(22) Filed: Sep. 13, 2012

(51) Int. Cl. H04L 29/06

(52) U.S. Cl. 713/156

(57) ABSTRACT

The invention relates to a portable device with access to several instances such that each of the instances performs an operation in response to a wireless data exchange with the portable device. The portable device comprises a data processing unit and a memory that stores a public key, a private key and a certificate. The portable device is further configured to transfer the certificate and the public key to a first instance. The first instance is configured to receive the first public key and the first certificate from the first portable device. The first instance is further configured to receive a signature from the first portable device, to decrypt the signature with the copy of the first public key so as receive a code, to compare the code with the random challenge and to perform the operation only if the code and random challenge match.

### BACKGROUND

Examples of wireless access systems are today's car entry and immobilization systems. These systems employ a single physical key or key fob for each car. The key or key fob can be used for a single car to which it is assigned. When a person approaches the car, presses specific buttons on the key or key fob or tries to start the engine of the car, a wireless data exchange occurs between the key and the car during which encrypted data is exchanged. The data is decrypted and evaluated at one or both ends for verification whether the correct key or key fob is used.

This kind of cryptography uses symmetric-key algorithms. Symmetric-key algorithms are a class of algorithms for cryptography that use, often identical, cryptographic electronic keys for both encryption and decryption. The electronic encryption key is trivially related to the decryption key, as they may be identical or only a rather simple transformation is applied. The cryptographic electronic keys are stored in the car and the physical key or key fob and represent a shared secret for maintaining a private information link.

If the verification process is successful and shows that the correct cryptographic and therefore the correct physical key fob is used, a specific operation is performed, for example the doors of the car unlock or the engine starts. Present systems require that basically the same secret cryptographic key is saved on both sides, (e. g. in the car and in the key fob). However, each copy or transfer of a secret cryptographic key increases the risk that any unauthorized third party copies the secret key and takes advantage of it.

### SUMMARY

It is an object of the invention to provide a system, a method, a portable device, and instances providing access to the portable device being adapted to flexibly provide access to multiple instances in a secure manner.

According to an aspect of the invention, a portable device for providing access to multiple instances is provided. Providing access to an instance means that the instance performs an operation in response to a wireless data exchange with the portable device. The portable device may comprise a data processing unit (for example a microcontroller, a central processing unit (CPU) or a hardware encryption accelerator), and a memory storing a first public key, a first private key and a first certificate indicating the first public key and a certificate authority that issued the first certificate. The first public key and the first private key are cryptographic keys in accordance with standard encryption and decryption procedures as known in the art. The portable device may then further be configured to transfer the first certificate and the first public key to a first instance out of the multiple instances for key paring based on the certificate and a public key of the certificate authority. This aspect of the invention provides that only a public key and a certificate from the certificate authority are transferred from the portable device to any other instance. The first private key remains only within the portable device.

The portable device can be configured to receive a random challenge (random data signal) from the first instance. The portable device can be adapted to encrypt the random challenge with the first private key in order to generate an encrypted signature. This encrypted signature can then be transferred to the first instance. The transfer or transmission of the random challenge and the encrypted signature are performed in a wireless manner.

The invention also provides an instance being configured to perform an operation in response to a wireless data exchange with the portable device. The instance may then be configured to receive the first public key and the first certificate from the portable device. A second public key from the certificate authority may either already be stored in the first instance or the first instance may be configured to receive the second public key from the certificate authority. The first instance can then be adapted to generate a copy of the first public key based on the first certificate and the second public key. The copy of the first public key can then be stored in the first instance. Furthermore, the first instance may then be configured to generate and to send a random challenge (a random data stream or data signal) to the portable device. The portable device can then generate a signature based on the random challenge using the first private key. This signature is sent back to the first instance and received by the first instance. The first instance can then be configured to decrypt the signature with the copy of the first public key so as to receive a code and to compare the code with the random challenge. If the code and the random challenge match, an operation is performed by the first instance. This operation is the operation that was requested by the portable device.

Public-key cryptography refers to a cryptographic system requiring two separate keys, one to lock or encrypt the plaintext, and one to unlock or decrypt the cyphertext. Neither key will do both functions. One of these keys is published or public and the other is kept private. If the lock/encryption key is the one published then the system enables private communication from the public to the unlocking key's owner. If the unlock/decryption key is the one published then the system serves as a signature verifier of documents locked by the owner of the private key. Although in this latter case, since encrypting the entire message is relatively expensive computationally, in practice just a hash of the message is encrypted for signature verification purposes.

This cryptographic approach according to aspects of the invention uses asymmetric key algorithms such as RSA and applies these algorithms in an manner to access systems, like vehicle entry and/or immobilizing.

The invention uses a public key and a private key, where neither key is derivable from knowledge of the other. The private key is used to transform the random challenge into an unreadable signature, which can only be decrypted by a different but matching public key. Furthermore, the authenticity of the public key can be checked as certificates of a certificate authority are issued and supplied to the portable device and the instances to be accessed.

The present invention does not require a secure initial exchange of one, or more, secret keys between the sender and receiver. It is then theoretically almost impossible for anyone to find the correct private key based on the knowledge of the public key. The pairs of public and private keys are based on mathematical relationships, as for example the integer factorization and discrete logarithm problems, which have no efficient solution.

The embodiments of the invention may use asymmetric key algorithms as for example, DSS (Digital Signature Standard), elliptic curve cryptography (ECC) techniques, RSA encryption algorithm, GPG (an implementation of OpenPGP), or PGP.

The invention also provides a system comprising a first portable device and first instance. The first portable device may then be configured to provide access to multiple instances such that each of the multiple instances performs an operation in response to a wireless data exchange with the portable device. The first instance is one of the multiple instances. The first portable device comprises a data processing unit and a memory storing a first public key, a first private key and first certificate indicating the first public key and a certificate authority that issued the first certificate. The portable device can then be configured to transfer the first certificate and the public key to the first instance, while the first instance receives the first public key and the first certificate from the first portable device, uses a second public key from the certificate authority to generate a copy of the first public key based on the first certificate and the second public key. The copy of the first public key can be stored. The first instance may then generate a random challenge which is sent to the first portable device. The first portable device generates a signature based on the random challenge using the first private key and returns the signature to the first instance. The first instance receives the signature from the first portable device, decrypts the signature with the copy of the first public key thereby generating a code. This code is compared with random challenge that has previously been sent to the portable device. If the random challenge and the code match, a specific operation is performed which relates to the portable device.

The present invention also provides a method of granting and/or denying access to multiple instances such that each of the instances only performs a specific operation in response to a wireless data exchange with a portable device that stores the first public key and the first private key. Accordingly, a first certificate for the first public key is created with a second public key of the certificate authority. The first certificate is stored in the portable device. The first certificate and the first public key are then transferred from the portable device to a first instance out of the multiple instances. A copy of the first public key is generated in the first instance using the second public key from the certificate authority and the first certificate. The copy of the public key is compared with the first public key received from the portable device in order to verify the authenticity of the first public key. A random challenge is generated in the first instance. The random challenge is transmitted to the portable device. A signature is generated in the portable device based on the received random challenge using the first private key stored in the portable device. The signature is then transmitted to the first instance. The signature is decrypted in the first instance using the first public key stored in the first instance. The decrypted signature is then compared with the random challenge and the operation is performed if the decrypted signature and the random challenge are identical.

The first certificate and the first public key may then be transferred from the portable device to a second instance out of the multiple instances. A copy of the first public key can be generated in the second instance using the second public key from the certificate authority and the first certificate. The copy of the first public key is then compared with the first public key received from the portable device in order to verify the authenticity of the first public key stored in the second instance. The second instance may then also generate a random challenge and transmit the random challenge to the portable device. The portable device can generate a signature based on the received random challenge using the first private key. The signature can then be transmitted to the second instance. The signature is decrypted in the second instance using the first public key. The decrypted signature is compared with the random challenge and if the decrypted signature and the random challenge match, a specific operation is performed that relates to the portable device and the first instance.

In the embodiments of the invention, the portable device may be a key fob or a car key. The first instance can be a vehicle, as for example a car or motorcycle. The first instance or the second instance may also be an entrance of a building, of an apartment or an office. The second instance may also be another vehicle, as, for example a car or a motorcycle. The first and the second instances are cars of the same car fleet, for example a car fleet of police cars.

### BRIEF DESCRIPTION OF DRAWINGS

Further aspects and characteristics of the invention ensue from the following description of the embodiments of the invention with reference to the accompanying drawings, wherein

FIG. 1 shows a simplified diagram illustrating a first aspect of the invention,

FIG. 2 shows a simplified diagram illustrating a second aspect of the invention,

FIG. 3 shows a simplified diagram illustrating a third aspect of the invention,

FIG. 4 shows a simplified diagram illustrating a fourth aspect of the invention,

FIG. 5 shows a simplified diagram illustrating a fifth aspect of the invention,

FIG. 6 shows a simplified diagram illustrating a sixth aspect of the invention,

FIG. 7 shows a simplified diagram illustrating a seventh aspect of the invention,

FIG. 8 shows a simplified diagram illustrating a eight aspect of the invention,

FIG. 9 shows a simplified diagram illustrating a ninth aspect of the invention, and

FIG. 10 shows a simplified diagram illustrating the application of the invention to multiple instances.

### DETAILED DESCRIPTION OF AN EXAMPLE EMBODIMENTS

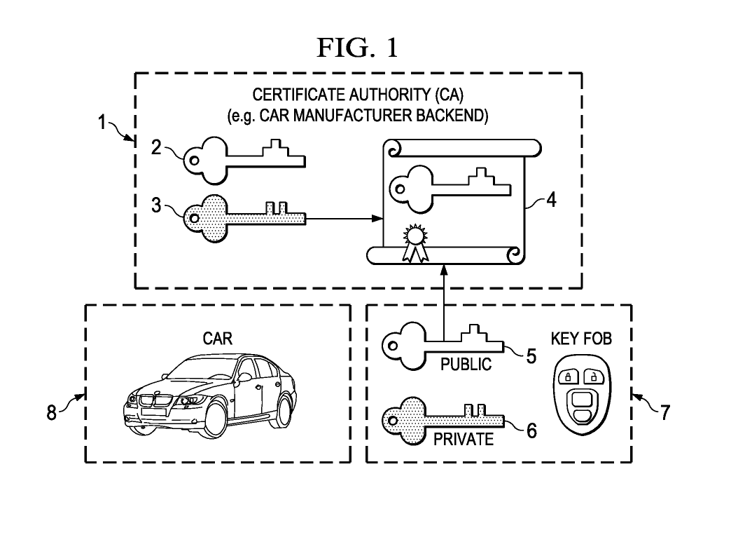

FIG. 1 shows a simplified diagram illustrating a first aspect of the invention. There is a certificate authority CA 1. The certificate authority CA 1 may be, for example a car manufacturer backend in this present embodiment of the invention. The certificate authority CA 1 holds a public key 2 and a private key 3. There is a portable device 7, which might be a key fob. The portable device 7 may contain a digital processing unit, as for example a microcontroller or a central processing unit CPU (not shown) or a hardware encryption accelerator). Furthermore, the portable device 7 may also include a memory, which is not shown either. The portable device 7 stores a public key 5 and a private key 6. The certificate authority CA 1 creates a certificate 4 for the public key 5 of the portable device 7 using its own private key 3. Furthermore, there is a first instance 8, as for example a car. The portable device 7 should serve to access the first instance 8. This means that the portable device 7 is to be configured to exchange data with the instance 8 according to a wireless data exchange subsequent to which the instance 8 performs a specific operation. In the present embodiment, this operation may consist in unlocking the doors of the car or starting the engine of the car. Accordingly, the present invention can be applied to automatic entry systems for vehicles, premises and/or other facilities as well as to vehicle immobilizers or other principles. In the embodiment shown in FIG. 1, the instance 8 may be considered a first instance of multiple instances (not shown) to which the aspects of the present invention can equally be applied.

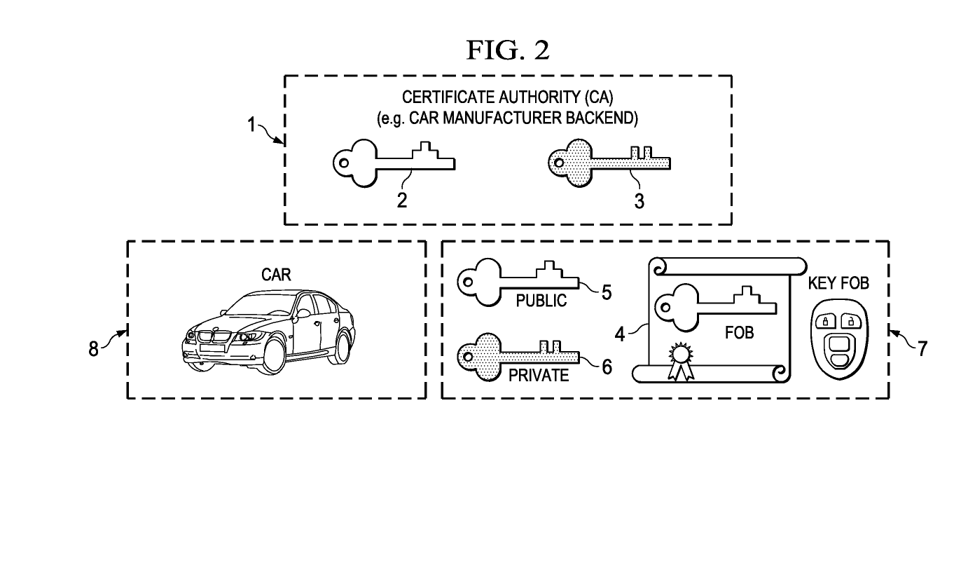

FIG. 2 shows a simplified diagram illustrating another aspect of the invention. After having created and issued the certificate 4, the certificate 4 is stored in the portable device 7 together with the public key 5 and the private key 6.

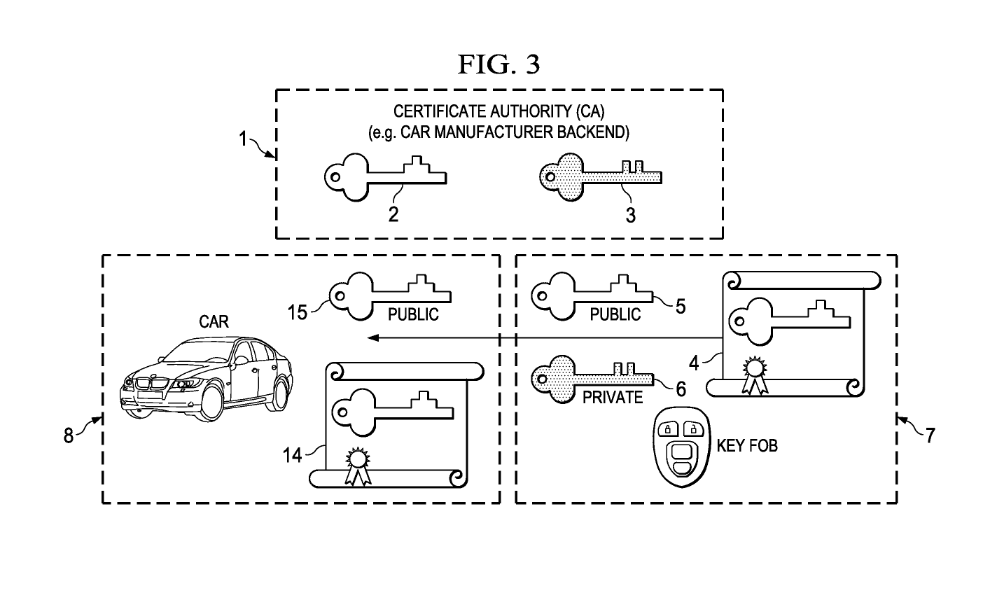

As shown in FIG. 3, the certificate 4 is transferred together with the public key 5 to the first instance 8. The copies of the public key 5 and the certificate 4 are referred to as public key 15 and certificate 14. The first public key 15 is then stored together with the first certificate 14 in a memory of the first instance 8.

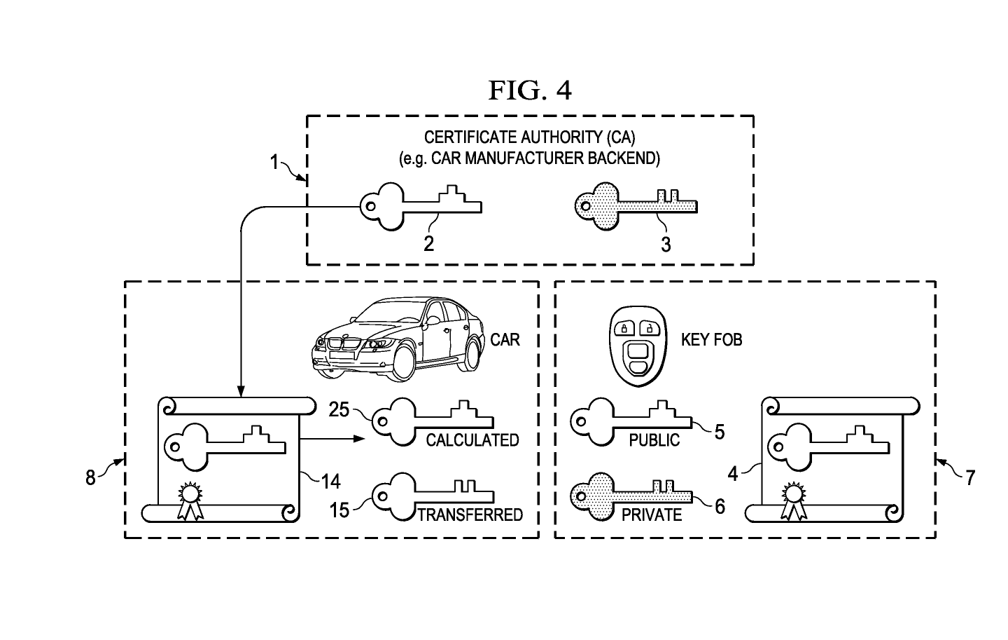

As illustrated in FIG. 4, the first instance 8 may calculate a public key 25 using the first certificate 14 and the public key 2 of the certificate authority CA 1. The public key 2 of the certificate authority CA 1 may either be transferred to the first instance 8 when the public key 2 is required, or the public key 2 may be stored within the first instance 8 already before the first public key 5 and the first certificate 4 are transferred from the portable device 7 to the first instance 8. The public key 5 of the portable device 7 is then re-calculated as public key 25 based on the first certificate 14 (which is a copy of certificate 4) and public key 2 of the certificate authority CA. If the calculated public keys 25 and the transferred public key 15 match, it is verified that the car received a valid and authentic first public key from the portable device 7. The verified public key from the portable device 7 may then be stored as public key 15 in the first instance. The first instance 8 and the portable device 7 are now ready for operation.

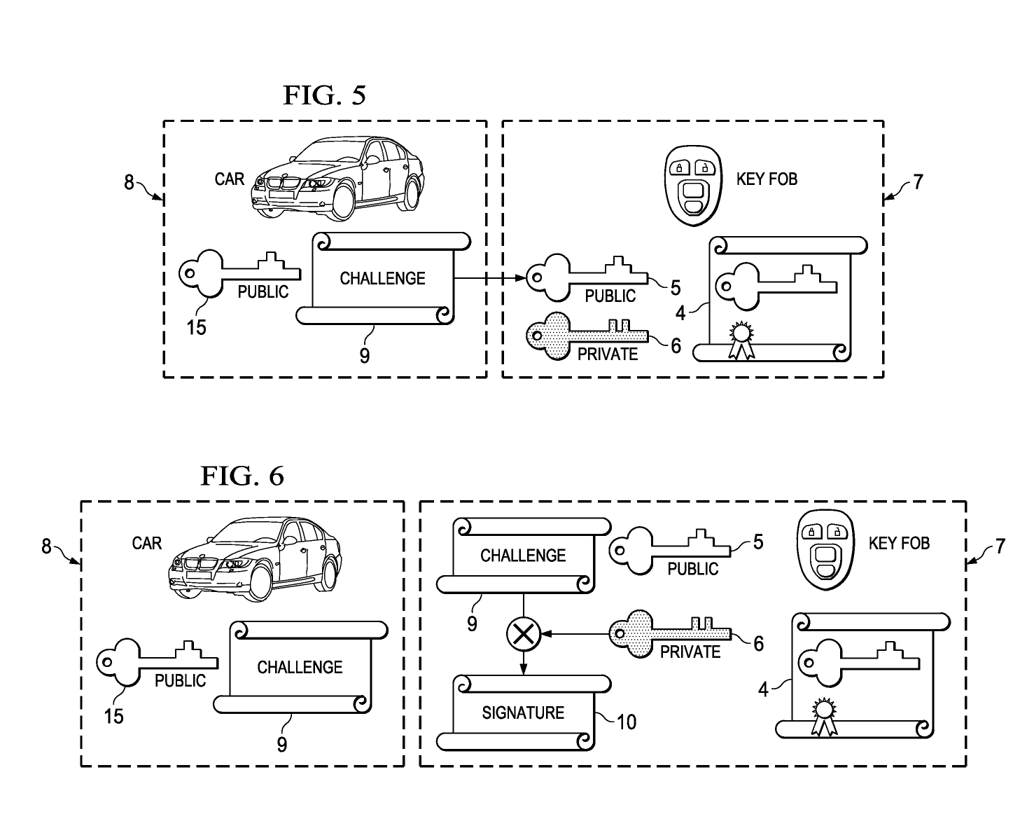

This operation is illustrated in FIG. 5 to FIG. 7. The operation may typically be an access to the first instance 8 (in this example a vehicle, as for example a car) using the portable device 7 (which is a key fob in this example). In order to initiate the access procedure, the first instance 8 generates a random challenge 9. This random challenge 9 may be a pseudo random number or pseudo random data. This random challenge 9 is transferred to the portable device 7 as shown in FIG. 5. The transfer of the random challenge is usually performed by wireless data transmission.

FIG. 6 illustrates how the portable device 7 receives the random challenge 9 and uses its private key 6 for encrypting the random data or random number of the challenge. Accordingly, a signature 10 is created based on the random challenge 9 and the private key 6 of the portable device 7.

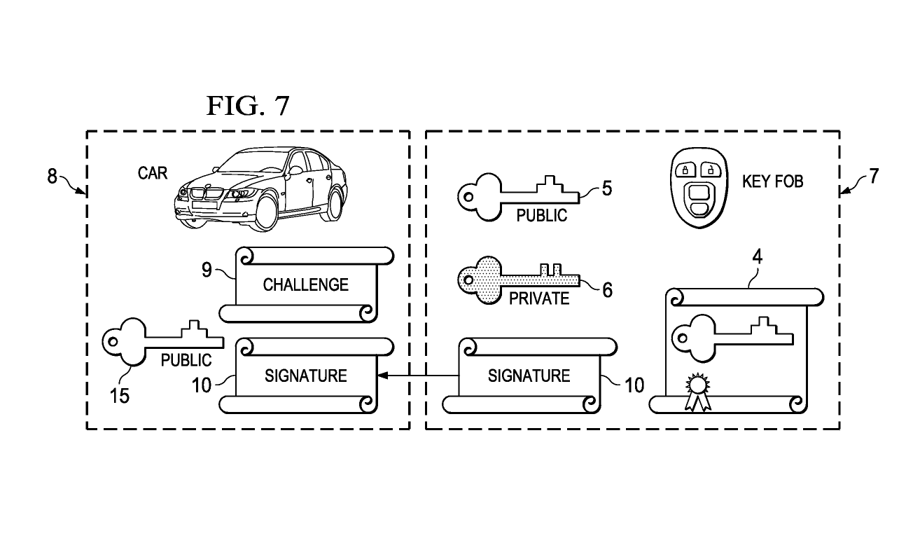

The encrypted signature 10 is then transferred to the first instance 8. This transfer is also performed using wireless data transmission. The transmission of the encrypted signature 10 is shown in FIG. 7.

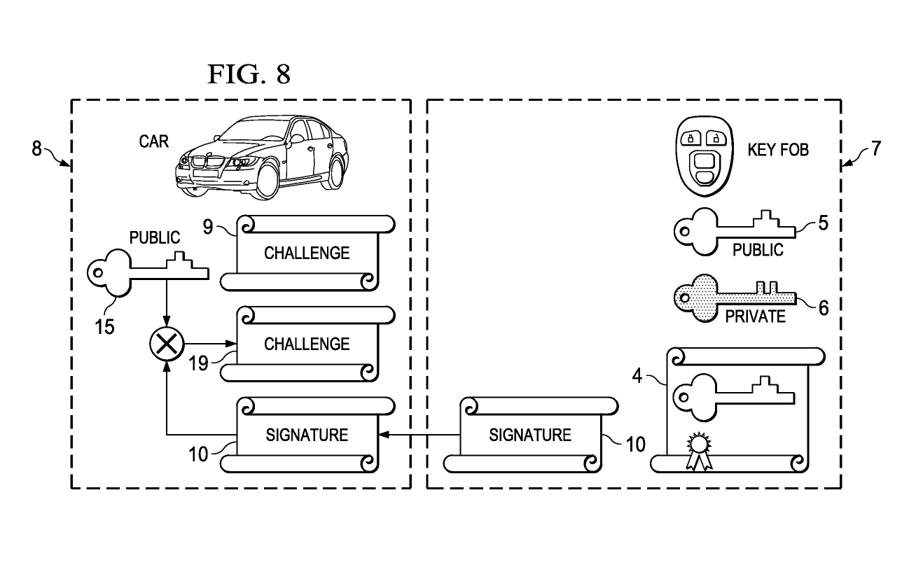

As shown in FIG. 8, the first instance 8 uses public key 15 (a copy of a first public key 5 of the portable device 7) for decrypting the signature 10. This results in a re-calculated random challenge 19.

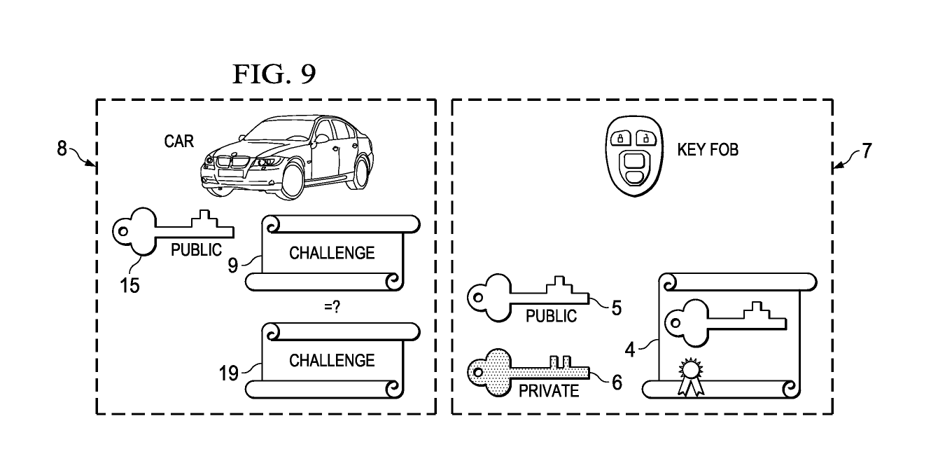

As shown in FIG. 9, the first instance 8 then compares the calculated random challenge 19 with the original random challenge 9. If the two random challenges 9 and 19 match, first instance 8 grants access. This means that a specific operation is performed. This operation may include unlocking the doors of the vehicle or deactivating the immobilizer in the vehicle in order to allow the engine to start.

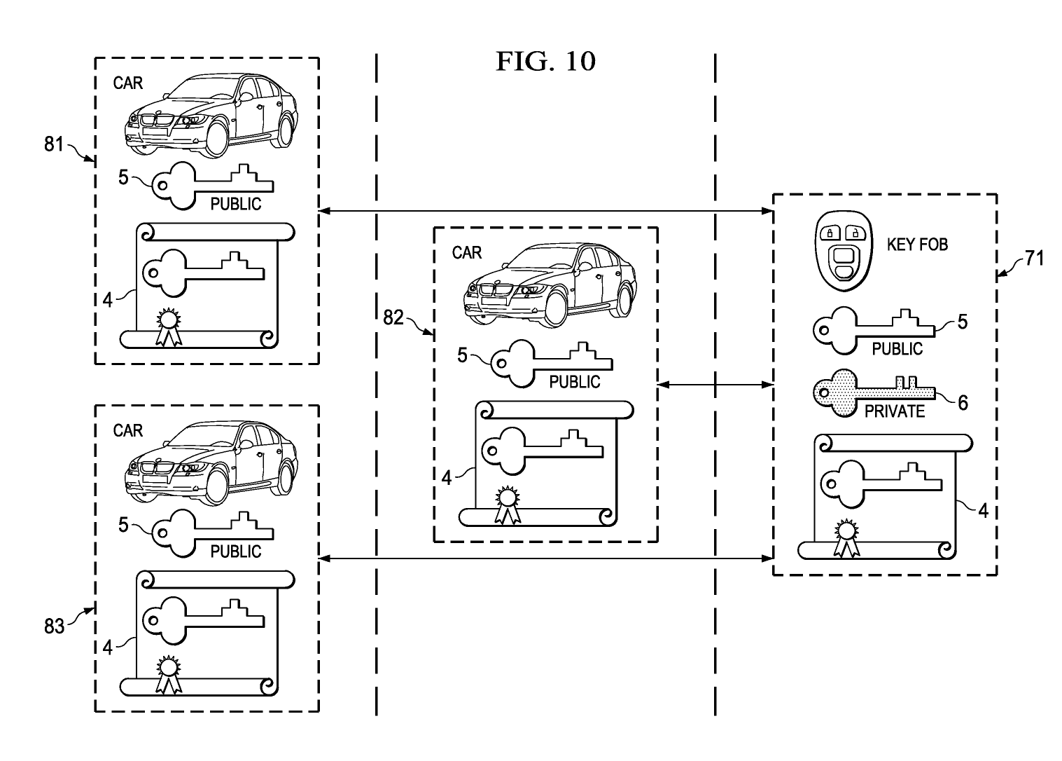

FIG. 10 shows a simplified diagram illustrating an aspect of the invention. According to this aspect of the invention, the principle that was explained with respect to FIG. 1 to FIG. 9 can be applied to multiple instances. The multiple instances 81, 82 and 83 may be vehicles of a car fleet, as, for example the cars of a fleet of police cars. Each of the instances 81, 82 and 83 may then store the public key 5 of the portable device 71 as well as the certificate 4 of the portable device 71 which was created with the private key 3 of the certificate authority CA 1 and then transferred to the portable device 71.

Although the invention has been described hereinabove with reference to specific embodiments, it is not limited to these embodiments and no doubt further alternatives will occur to the skilled person that lie within the scope of the invention as claimed.

1. A portable device for providing access to multiple instances such that each of the multiple instances performs an operation in response to a wireless data exchange with the portable device, the portable device comprising a data processing unit and a memory storing a first public key, a first private key and a first certificate indicating the first public key and a certificate authority that issued the first certificate, wherein the portable device is further configured to transfer the first certificate and the first public key to a first instance out of the multiple instances for key paring based on the certificate and a public key of the certificate authority.

2. The portable device according to claim 1, being further configured to receive a random challenge from the first instance and to encrypt the random challenge with the first private key in order to generate an encrypted signature.

3. The portable device according to claim 2, being further configured to transfer the encrypted signature to the first instance.

4. An instance being configured to perform an operation in response to a wireless data exchange with the portable device according to anyone of claims 1 to 3, wherein the instance is configured to receive the first public key and the first certificate from the portable device, to receive and/or store a second public key from the certificate authority, to generate a copy of the first public key based on the first certificate and the second public key, to store a copy of the first public key, to generate a random challenge, to send the random challenge to the portable device, to receive a signature from the portable device that is generated based on the random challenge and the first private key, to decrypt the signature with the copy of the first public key so as receive a code, to compare the code with the random challenge and to perform the operation only if the code and random challenge match.

5. A system comprising a first portable device and a first instance, wherein the first portable device is configured to provide access to multiple instances such that each of the multiple instances perform an operation in response to a wireless data exchange with the portable device, and the first instance is one of the multiple instances, wherein the first portable device comprises a data processing unit and a memory storing a first public key, a first private key and a first certificate indicating the first public key and a certificate authority that issued the first certificate, wherein the portable device is further configured to transfer the first certificate and the first public key to the first instance, the first instance is configured to receive the first public key and the first certificate from the first portable device, to receive and/or store a second public key from the certificate authority, to generate a copy of the first public key based on the first certificate and the second public key, to store a copy of the first public key, to generate a random challenge, to send the random challenge to the first portable device, wherein the first portable device is configured to generate a signature with the random challenge and the first private key and to send the signature to the first instance, wherein the first instance is further configured to receive the signature from the first portable device, to decrypt the signature with the copy of the first public key so as receive a code, to compare the code with the random challenge and to perform the operation only if the code and random challenge match.

6. A method of granting and/or denying access to multiple instances such that each of the instances only performs a specific operation in response to a wireless data exchange with a portable device that stores a first public key and a first private key, the method comprising: creating a first certificate for the first public key using a second public key of a certificate authority; storing the first certificate in the portable device; transferring the first certificate and the first public key from the portable device to a first instance out of the multiple instances; generating a copy of the first public key in the first instance using the second public key from the certificate authority and the first certificate; comparing the copy of the first public key with the first public key received from the portable device in order to verify the authenticity of the first public key; generating a random challenge in the first instance; transmitting the random challenge to the portable device; generating a signature in the portable device based on the received random challenge using the first private key; transmitting the signature to the first instance; decrypting the signature in the first instance using the first public key; comparing the decrypted signature with the random challenge, and performing the operation if the decrypted signature and the random challenge are identical.

7. The method according to claim 6, further comprising: transferring the first certificate and the first public key from the portable device to a second instance out of the multiple instances; generating a copy of the first public key in the second instance using the second public key from the certificate authority and the first certificate; comparing the copy of the first public key with the first public key received from the portable device in order to verify the authenticity of the first public key in the second instance; generating a random challenge in the second instance; transmitting the random challenge to the portable device; generating a signature in the portable device based on the received random challenge using the first private key; transmitting the signature to the second instance; decrypting the signature in the second instance using the first public key; comparing the decrypted signature with the random challenge, and performing the operation at the first instance if the decrypted signature and the random challenge are identical.
